(19) United States
(12) Patent Application Publication
(10) Pub. No.: US 2023/0336947 A1
(43) Pub. Date: Oct. 19, 2023

(54) Data Analysis System, Server Device, Data Analysis Method and Data Analysis Program

(71) Applicant: Nippon Telegraph and Telephone Corporation, Tokyo (JP)

(72) Inventors: Rieko Sato, Tokyo (JP); Takayuki Ogasawara, Tokyo (JP); Kenichi Matsunaga, Tokyo (JP)

(21) Appl. No.: 18/041,921

(22) PCT Filed: Sep. 30, 2020
(86) PCT No.: PCT/JP2020/037126

§ 371 Date: Feb. 16, 2023

(51) Int. Cl. H04W 4/029

(52) U.S. Cl. CPC H04W 4/029

(57) ABSTRACT

A data analysis system includes: a data acquisition unit that acquires sensor data including user identification information; a data collection processing unit that collects the sensor data from a predetermined region as a target; a data analysis unit that calculates the number of users who are staying in the predetermined region based on the user identification information; an estimation unit that estimates density of the users based on the number of the users; and an alert display unit that displays the density.

### CROSS-REFERENCE TO RELATED APPLICATIONS

This application is a national phase entry of PCT Application No. PCT/JP2020/037126, filed on Sep. 30, 2020, which application is hereby incorporated herein by reference.

### TECHNICAL FIELD

The present invention relates to a data analysis system, a server device, a data analysis method, and a data analysis program for estimating density of people.

### BACKGROUND

Recently, efforts to avoid crowding of people have been implemented in various places as a part of infectious disease countermeasures. Systems that detect density and encourage users to avoid crowding are particularly needed in stores, medical facilities, event sites, and the like where many people gather. Also, such systems are needed in cases of disasters or the like.

Patent Literature 1 discloses a system for alleviating congestion using a mobile phone such as a smartphone.

Also, Non Patent Literature 1 discloses a system that collects living body and physical activity information of a patient hospitalized for rehabilitation for 24 hours and assists with rehabilitation and recovery. The system does not require carrying of a smartphone as an essential matter and realizes an environment with no load on a user by collecting data from a sensor terminal via a data relay device.

### CITATION LIST

### Patent Literature

Patent Literature 1: Japanese Patent No. 6215796

### Non Patent Literature

Non Patent Literature 1: NTT Technical Journal, July 2018, pp. 10 to 14

### SUMMARY

### Technical Problem

However, according to the system disclosed in Patent Literature 1, it is necessary for the user to carry a smartphone as a mobile terminal. However, a case in which a user does not carry a smartphone or does not look at it even if they carry it is assumed when the user is an elderly person.

On the other hand, according to the system disclosed in Non Patent Literature 1, it is not possible to realize alleviation of congestion and avoidance of crowding.

### Solution to Problem

In order to solve problems like that described above, a data analysis system according to embodiments of the present invention includes: a data acquisition unit that acquires sensor data including user identification information; a data collection processing unit that collects the sensor data from a predetermined region as a target; a data analysis unit that calculates the number of the users who are staying in the predetermined region based on the user identification information; an estimation unit that estimates density of the users based on the number of the users; and an alert display unit that displays the density.

Also, a data analysis system according to embodiments of the present invention includes: a sensor terminal device that is attached to a user; a relay terminal device; a server device; and an alert display device, in which the sensor terminal device acquires sensor data including user identification information and transmit the sensor data to the relay terminal device, the relay terminal device collects the sensor data in a region where the relay terminal device is able to receive the sensor data and transmits the sensor data to the server device, the server device receives the sensor data from the relay terminal device, calculates the number of the users who are staying in each region based on the user identification information, and estimates density of the users based on the number of the users, and the alert display device is disposed in the vicinity of the relay terminal device and displays the density of the users.

Also, a server device according to embodiments of the present invention includes a reception unit that receives sensor data including user identification information; an ID number calculation unit that calculates the number of users who are staying in a predetermined region based on the user identification information; an estimation unit that estimates density of the users based on the number of users; and a transmission unit that transmits the density to an alert display device.

Also, a data analysis method according to embodiments of the present invention includes: calculating the number of users who are staying in a predetermined region based on user identification information included in sensor data acquired from a sensor attached to a user; and analyzing density of the users in the predetermined region based on the number of the users.

A data analysis method according to embodiments of the present invention includes the steps of: acquiring sensor data from a sensor attached to a user; calculating the number of the users who are staying in a predetermined region based on user identification information included in the sensor data; and estimating that the density is low in a case in which the number of the users who are staying in the predetermined region is less than a lower limit value of the number of the users.

Also, a data analysis program according to embodiments of the present invention causes a data analysis system that analyzes density of users based on sensor data acquired from a sensor attached to a user to function to execute processing of: calculating the number of the users who are staying in a predetermined region based on user identification information included in the sensor data and analyzing density of the users in the predetermined region based on the number of the users.

### Advantageous Effects of Embodiments of Invention

According to embodiments of the present invention, it is possible to provide a data analysis system, a server device, a data analysis method, and a data analysis program for estimating density of people in the vicinity of a user.

### BRIEF DESCRIPTION OF THE DRAWINGS

FIG. 1 is a block diagram illustrating a configuration of a data analysis system according to a first embodiment of the present invention.

FIG. 2 is a block diagram illustrating a configuration of a data analysis unit in the data analysis system according to the first embodiment of the present invention.

FIG. 3 is a flowchart of a data analysis method according to the first embodiment of the present invention.

FIG. 4 is an overview illustrating a configuration example of the data analysis system according to the first embodiment of the present invention.

FIG. 5 is a diagram for explaining an example of operations of the data analysis system according to the first embodiment of the present invention.

FIG. 6A is a diagram for explaining operations of the data analysis system according to a first example of the present invention.

FIG. 6B is a diagram for explaining operations of the data analysis system according to the first example of the present invention.

FIG. 6C is a diagram for explaining operations of the data analysis system according to the first example of the present invention.

FIG. 6D is a diagram for explaining operations of the data analysis system according to the first example of the present invention.

FIG. 7 is a diagram illustrating a configuration example of a computer according to an embodiment of the present invention.

### DETAILED DESCRIPTION OF ILLUSTRATIVE EMBODIMENTS

### First Embodiment

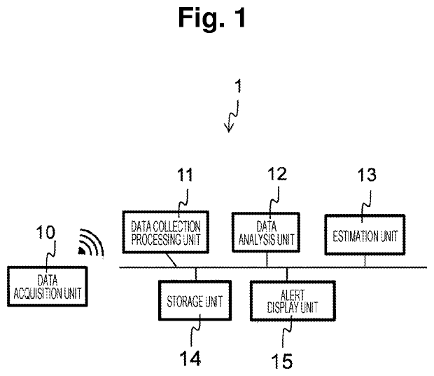

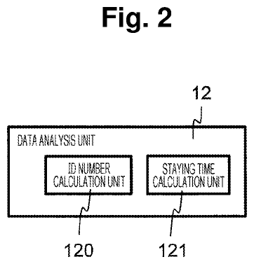

A data analysis system according to a first embodiment of the present invention will be described with reference to FIGS. 1 and 2.

<Configuration of Data Analysis System>

A data analysis system 1 according to the present embodiment includes a data acquisition unit 10, a data collection processing unit 11, a data analysis unit 12, an estimation unit 13, a storage unit 14, and an alert display unit 15 as illustrated in FIG. 1. In particular, the data analysis system 1 includes the data analysis unit 12 that analyzes density of users, the estimation unit 13 that estimates the density of the users, and the alert display unit 15 that displays how high or low the density of the users is.

In the data acquisition unit 10, biological information, environmental information, and the like of the users are acquired as sensor data by wearable sensors. Examples of the sensors include heart rate monitors, electrocardiographs, sphygmomanometers, pulse monitors, respiration sensors, thermometers, and brain wave sensors.

The data collection processing unit 11 collects sensor data acquired by the data acquisition unit 10 at a specific time cycle and adds clock time information thereto. Also, the sensor data is accompanied by user identification information (user ID information) and is stored along with the clock time information in the storage unit 14.

In addition, the data analysis unit 12 includes an ID number calculation unit 120 that counts the number of IDs of users who are staying in a predetermined region where a relay terminal device (which will be described later) can perform communication (reception) based on the user ID information as illustrated in FIG. 2. In other words, the ID number calculation unit 120 calculates the number of users who are staying in the predetermined region.

Also, the data analysis unit 12 includes a staying time calculation unit 121 that calculates staying times during which the users stay in the predetermined region based on the clock time information.

Although the data analysis unit 12 performs analysis of the sensor data such as the biological information and the environmental information collected by the data collection processing unit 11, the analysis is not essential in the present invention, and thus will not be described in detail.

The estimation unit 13 estimates user density in the vicinity of the relay terminal device from the number of user IDs and the staying times described above, and the alert display unit 15 provided in the vicinity of the relay terminal device displays the result to encourage the users to avoid crowding. Hereinafter, “disposition in the vicinity of the relay terminal device” includes a case in which it is disposed in the surroundings of the relay terminal device and also includes a case in which it is integrated with the relay terminal device and is attached to and disposed with the relay terminal device.

The alert display unit 15 is realized by a signal lamp or a monitor of a liquid crystal display, for example.

According to the data analysis system 1 of the present embodiment, it is possible to estimate and display density of users for each region that is targeted by each relay terminal device. Here, the data analysis system 1 can exhibit basic functions without including the storage unit 14.

<Data Analysis Method>

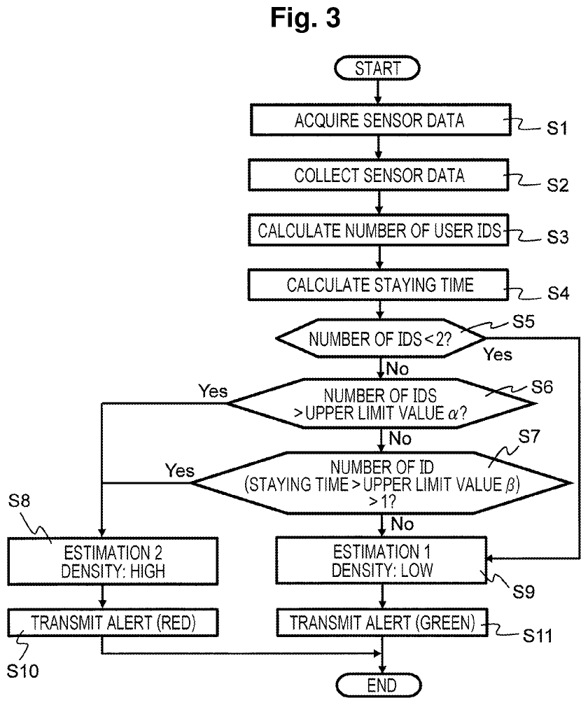

Next, a data analysis method according to the present embodiment will be described with reference to FIG. 3.

In the data analysis system 1, the data acquisition unit 10 acquires sensor data including biological information and the like measured by the sensor 105 for each user first (Step S1).

Next, the data collection processing unit 11 collects sensor data of a plurality of users from the data acquisition unit 10 at a specific cycle (Step S2). At this time, each piece of sensor data includes user ID information.

Thereafter, the ID number calculation unit 120 calculates the total number of user IDs, in other words, the number of users, in a predetermined region of each relay terminal device (Step S3). Time-series data of the number of user IDs calculated by the ID number calculation unit 120 is accumulated in the storage unit 14.

Next, the staying time calculation unit 121 calculates a staying time of each user based on the clock time information added to the sensor data (Step S4), and the time-series data is accumulated in the storage unit 14.

Next, in a case in which the total number of the user IDs (the number of the users) is 0 or 1 (in a case in which the total number of the user IDs is less than two, in other words, in a case in which the total number of the user IDs <2) (Step S5: YES), the estimation unit that estimates density of the users determines that “estimation 1: density is low” regardless of the staying times (Step S9).

On the other hand, in a case in which the total number of the user IDs (the number of the users) is equal to or greater than two (Step S5: NO), and an upper limit value α of the number of the users defined in advance is exceeded (Step S6: YES), it is determined that “estimation 2: density is high” regardless of the staying times (Step S8).

In a case in which the number of the user IDs (the number of the users) is equal to or greater than two and equal to or less than a (Step S6: NO), and the number of the user IDs (the number of the users) staying in the predetermined region for staying times exceeding an upper limit value β is equal to or greater than two (Step S7: YES), it is determined that “estimation 2: density is high” (Step S8). Also, in a case in which the number of the user IDs (the number of the users) staying for staying times exceeding the upper limit value β is 1 (Step S7: NO), it is determined that “estimation 1: density is low” (Step S9).

In a case in which the density is estimated to be high (Step S8), an alert is transmitted to the alert display unit 15 such that it performs display in red (Step S10). Also, in a case in which the density is determined to be low, an alert is transmitted such that the alert display unit 15 performs display in green, for example (Step S11).

Although the example in which the density is estimated based on the number of the users and the staying times in the predetermined region has been described in the present embodiment, the present invention is not limited thereto, and it is also possible to estimate the density based on only the number of the users in the predetermined region. For example, the density may be estimated to be low in the case of Yes and may be estimated to be high in the case of No in Step S5.

Here, it is possible to improve accuracy of the estimation of density by estimating the density using the staying times in addition to the number of the users in the predetermined region as described in the present embodiment.

Although the example in which determination is made when the value is less than/equal to or greater than “2,” in other words, using “2” as a reference value” (the lower limit value of the number of the users) in Step S5, has been described in the present embodiment, the present invention is not limited thereto, and a lower limit value other than “2” may be used. For example, the lower limit value of the number of the users may be set to be a higher value if the predetermined region is wider, or may be set to be a lower value if the predetermined region is narrower.

### Configuration Example of Data Analysis System

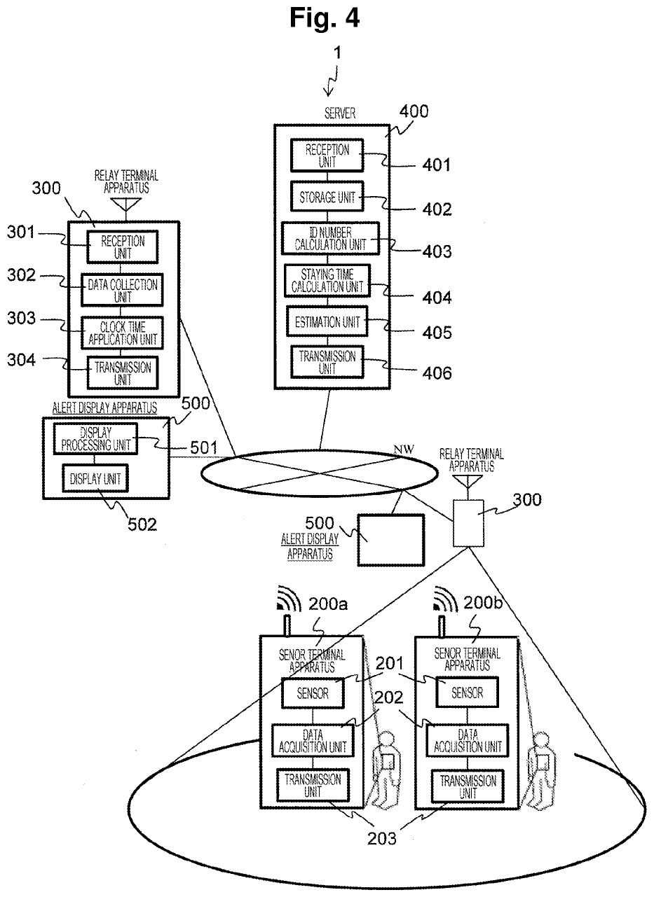

Next, a configuration example of the data analysis system according to the present embodiment will be described with reference to FIG. 4.

In the data analysis system 1, a plurality of relay terminal devices are placed at stores, medical facilities, event sites, and the like. Data acquired by sensors attached to the users is transmitted to each relay terminal device, and the data is further transmitted from each relay terminal device to the server device and is then analyzed.

The data analysis system 1 includes, for example, sensor terminal devices 200a and 200b that are attached to users, relay terminal devices 300(1 to N), a server device 400, and alert display devices 500(1 to N) as illustrated in FIG. 4.

All or some of the sensor terminal devices 200a and 200b, the data relay terminal devices 300, the server device 400, and the alert display devices 500 include each function included in the data analysis system such as the data analysis unit 12 illustrated in FIGS. 1 and 2.

Note that data acquisition units 202 in the sensor terminal devices 200a and 200b are included in the data acquisition unit 10 illustrated in FIG. 1 in the following description.

Also, data collection units 302 and clock time application units 303 in the relay terminal devices 300 are included in the data collection processing unit 11 illustrated in FIG. 1.

In addition, an ID number calculation unit 403 and a staying time calculation unit 404 in the server device 400 are included in the data analysis unit 12 illustrated in FIG. 1. Moreover, an estimation unit 405 is included in the estimation unit 13 illustrated in FIG. 1.

Also, display units 502 in the alert display devices 500 are included in the alert display unit 15 illustrated in FIG. 1.

<Functional Blocks of Sensor Terminal Device>

The sensor terminal devices 200a and 200b include sensors 201, data acquisition units 202, and transmission units 203 as illustrated in FIG. 4. The sensor terminal devices 200a and 200b measure sensor data including biological information and physical information of bodies by being disposed at body trunks or the like and being attached to the users, for example.

The sensor terminal devices 200a and 200b transmit the measured biological information and the like of the users to the relay terminal devices 300 via wireless communication. At this time, the sensor data includes user ID information. As the sensor terminal devices 200a and 200b, wristwatch-type or clothing-type wearable terminals, for example, are used.

The transmission units 203 transmit the sensor data including the user ID information and acquired by the data acquisition unit 202 to the relay terminal devices 300. The transmission units 203 can transmit the sensor data to the relay terminal device 300 via wireless communication such as BLE or Wi-Fi, for example.

<Functional Blocks of Relay Terminal Device>

A plurality of relay terminal devices 300(N) are placed in predetermined indoor region, and each of the relay terminal devices independently has a communication area constituted by the sensor terminal devices (200a, 200b, and the like). The relay terminal device 300 transmits data to the server device 400 via a communication network NW.

The relay terminal device 300 includes a reception unit 301, a data collection unit 302, a clock time application unit 303, and a transmission unit 304 as illustrated in FIG. 4.

The reception unit 301 receives sensor data including the user ID information and acquired by the sensor terminal devices 200a and 200b. The sensor data for each user collected by the data collection unit 302 at a specific cycle is transmitted from the transmission unit 304 to the server device 400 via the communication network NW after clock time information is added thereto by the clock time application unit 303.

<Functional Blocks of Server device>

The server device 400 includes a reception unit 401, a storage unit 402, an ID number calculation unit 403, a staying time calculation unit 404, an estimation unit 405, and a transmission unit 406.

The reception unit 401 receives sensor data from the relay terminal devices 300, and the received sensor data is stored in the storage unit 402.

The ID number calculation unit 403 and the staying time calculation unit 404 calculate the number of the user IDs and the staying times based on the received sensor data, respectively.

The estimation unit 405 estimates user density based on the calculated number of the user IDs and the staying times.

The transmission unit 406 transmits the estimation result of the user density to the alert display devices 500 via a network. Here, N (the same as the number of relay terminal devices 300) alert display devices 500 are placed in the vicinity of the relay terminal devices 300 and include display processing units 501 and display units 502.

<Operation Sequence of Data Analysis System>

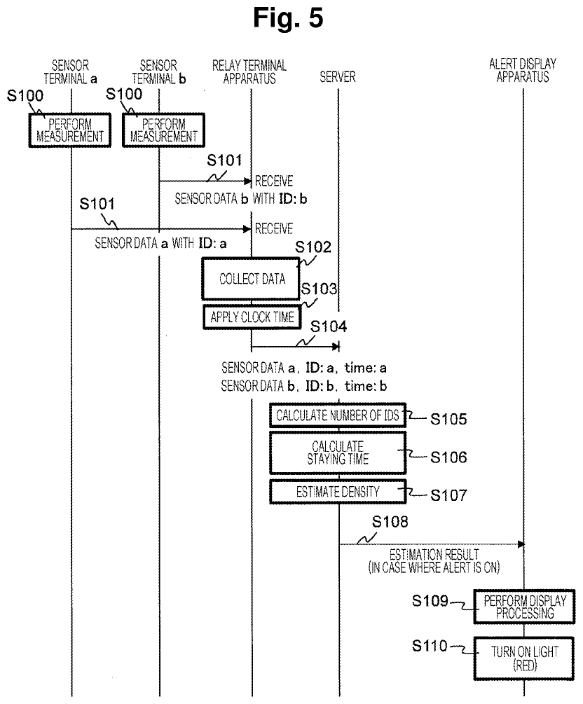

Next, an example of operations of the data analysis system will be described with reference to FIG. 5. As an example, a case in which the estimation result indicates that the alert is to be ON (density is high) when two users attach sensor terminal devices 200a and 200b to themselves and move in a target facility will be described.

First, sensors 201 in the sensor terminal devices 200a and 200b attached to the users measure biological information and the like (Step S100).

Next, the biological information and the like measured by the sensor terminal devices 200a and 200b are acquired as sensor data a and b by the data acquisition unit 202, respectively. The sensor data a and b is transmitted by the transmission units 203 to the relay terminal device 300 via BLE or Wi-Fi (Step S101).

Here, each piece of sensor data includes information (ID: a, ID: b) for identifying the users. As the identification information, it is possible to use MAC addresses, identification information linked to user information in advance, or the like.

The relay terminal device 300 receives and collects sensor data acquired by the sensor terminal devices 200a and 200b at a specific cycle using the reception unit 301 and the data collection unit 302 (Step S102).

Next, the clock time application unit 303 adds clock time information to the collected sensor data of the plurality of users (Step S103). For example, clock times (time: a, time: a) are added to sensor data a and b, respectively.

The sensor data with the clock times added thereto is transmitted from the transmission unit 304 to the server device 400 via the communication network NW (Step S104). For example, sensor data a (ID: a, time: a) and sensor data b (ID: b, time: b) are transmitted.

Next, the server device 400 calculates the number of the user IDs using the ID number calculation unit 403 from the sensor data of the users received in a specific time cycle (Step S105).

Next, the staying time calculation unit 404 calculates staying information (staying time) of each user from the clock time information (Step S106).

Next, the estimation unit 405 estimates density of the users in a specific time cycle based on the calculated number of the user IDs and the staying information (staying times) (Step S107).

In a case in which the density is estimated to be high, a signal indicating that the alert is to be turned ON is transmitted to the alert display device 500 (Step S108).

Next, the alert display device 500 performs processing of causing the display processing unit 501 to receive a command from the server device and turn on a signal light in red or cause the signal light to blink, for example (Step S109).

Finally, the display unit 502 is turned on in red or blinks (Step 110).

As described above, according to the data analysis system of the present embodiment, it is possible to estimate density of the users for each region targeted by each relay terminal device in a building or a facility without requiring the users to carry smartphones. Therefore, it is possible to alleviate crowding and congestion of the users through warning by the users themselves or a third party by visually displaying density in the vicinity of the users, for example, by displaying an alert when density in each region is high.

### First Example

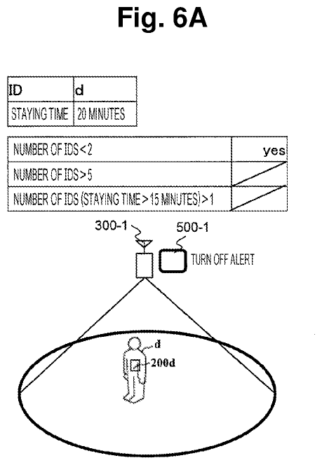

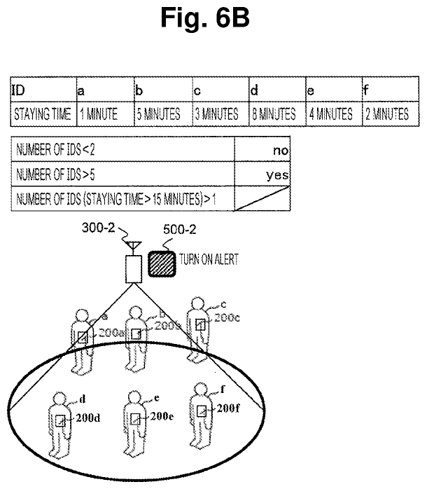

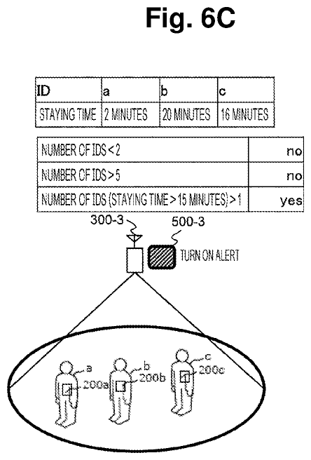

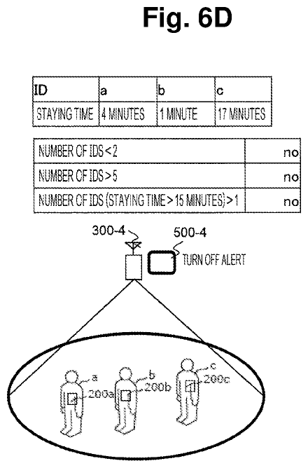

Next, a data analysis system according to a first example of the present invention will be described with reference to FIGS. 6A to 6D.

The present example will be described on the assumption that the upper limit value α of the total number of user IDs defined in advance is five and the upper limit value β of the staying times is 15 minutes.

First, a case in which one user stays in a target region for 20 minutes will be assumed as illustrated in FIG. 6A. In this case, the staying time exceeds the upper limit value β while the total number of the user IDs does not exceed two (0 or 1), determination in Step S5 illustrated in FIG. 3 is Yes, the density is thus estimated to be low, and the alert signal is turned off. Here, the alert signal may be turned on with a blue or green color.

Next, a case in which six users stay in a target region for 1 minute, 5 minutes, 3 minutes, 8 minutes, 4 minutes, and 2 minutes, respectively, will be assumed as illustrated in FIG. 6B. In this case, the total number of the user IDs is equal to or greater than two and exceeds the upper limit value α (=5), determination in Step S6 illustrated in FIG. 3 is thus Yes, the density is estimated to be Yes, and the alert signal is turned on. Here, the alert signal may be turned on with a red color or the like.

Next, a case in which three users stay in a target region for 2 minutes, 20 minutes, and 16 minutes, respectively, will be assumed as illustrated in FIG. 6C. In this case, the total number of the user IDs is equal to or greater than two and is equal to or less than the upper limit value α (=5), the number of IDs staying for staying times exceeding the upper limit value β (15 minutes) is two, determination in Step S7 illustrated in FIG. 3 is thus Yes, the density is estimated to be high, and the alert signal is turned on. Here, the alert signal may be turned on with a red color or the like.

Next, a case in which three users stay in a target region for 4 minutes, 1 minutes, and 17 minutes, respectively, will be assumed as illustrated in FIG. 6D. In this case, the total number of the user IDs is equal to or greater than two and is equal to or less than the upper limit value α (=5), and the number of IDs staying for staying times exceeding the upper limit value β (15 minutes) is one, determination in Step S7 illustrated in FIG. 3 is No, the density is determined to be low, and the alert signal is turned off. Here, the alert signal may be turned on with a blue or green color.

Although the upper limit values a and 13 defined in advance are defined as 5 minutes and 15 minutes, respectively, in this example, a system administrator may determine them in consideration of a predetermined communication available region of the relay terminal device, user distances with which infection prevention measures can be sufficiently secured in practice, or staying time.

According to the data analysis system of this example, it is possible to estimate density of users for each region targeted by each relay terminal device in a building or a facility without requiring users to carry smartphones with themselves as described above. Therefore, it is possible to alleviate crowding and congestion of the users through warning by the users themselves or a third party by displaying density in the vicinity of the users, for example, by displaying an alert when density in each region is high.

Although the example in which the data analysis system and the server device according to the embodiment and the example of the present invention have a function of adding clock time information to sensor data, a function of calculating staying times based on the clock time information, and a function of estimating density using the number of users and staying times in a predetermined region has been described, the present invention is not limited thereto. It is also possible to estimate density using only the number of users in the predetermined region without having the function of adding clock time information to sensor data and the function of calculating staying times based on the clock time information.

Although the example in which the alert display unit and the alert display device display density by being turned on with a red color or the like or blinking has been described in the embodiment and the example of the present invention, the present invention is not limited thereto, and the display may be performed using not only the color but also a text, illustration, a pattern, or the like. A mode in which a color, a text, or the like is displayed in a case in which the density is determined to be high and no display is performed in a case in which the density is determined to be low may be employed. It is only necessary to be able to visually identify whether the density is high/low.

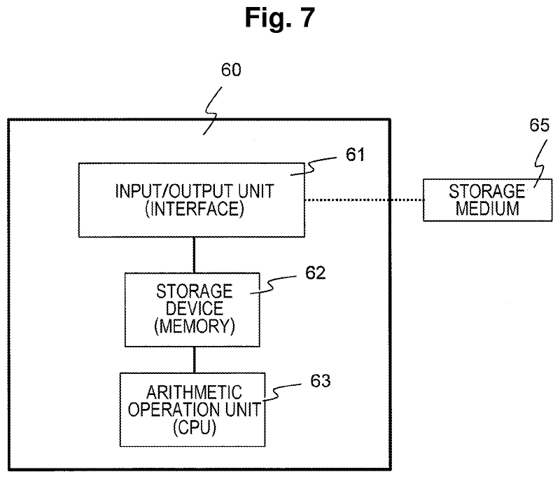

FIG. 7 illustrates a configuration example of a computer in the data analysis system according to the embodiment of the present invention. The data analysis system can be realized by a computer 60 including a central processing unit (CPU) 63, a storage device (storage unit) 62, and an interface device 61, and a program for controlling these hardware resources. Here, a reception unit and a transmission unit are connected to the interface device 61. The CPU 63 executes the processing according to the embodiment of the present invention in accordance with a data analysis program stored in the storage device 62. The data analysis program causes the data analysis system to function in this manner.

The data analysis system according to the embodiment of the present invention may include the computer inside the device or may realize at least some of functions of the computer using an external computer. Also, a storage medium 65 outside the device may be used as the storage device, and the data analysis program stored in the storage medium 65 may be read and executed. The storage medium 65 includes various magnetic recording media, magnetooptical recording media, a CD-ROM, a CD-R, and various memories. Also, the data analysis program may be supplied to the computer via a communication line such as the Internet.

Although an example of a structure and the like of each component has been described as a configuration of the data analysis system in the embodiment of the present embodiment, the present invention is not limited thereto. Any structures may be used as long as functions of the data analysis system are realized and effects thereof are achieved.

### INDUSTRIAL APPLICABILITY

Embodiments of the present invention can be applied to the fields of environments, health care, disaster prevention, and the like as an device, a system, or the like for avoiding crowding of people in buildings, facilities, and the like.

### REFERENCE SIGNS LIST

1 Data analysis system
10 Data acquisition unit
11 Data collection processing unit
12 Data analysis unit
13 Estimation unit
14 Storage unit
15 Alert display unit.

1-8. (canceled)

9. A data analysis system comprising:
a data acquisition device configured to produce sensor data, the sensor data including data acquired by a sensor attached to a user and user identification information for identifying the user;
a data collection processing device configured to collect the sensor data from a predetermined region as a target;
a data analysis device configured to calculate the number of users staying in the predetermined region based on the user identification information;
an estimation device configured to estimate density of the users based on the number of the users; and
an alert display device configured to display the density of the users.

10. A data analysis system according to claim 9, wherein:
the data acquisition device includes a plurality of sensor terminal devices each configured to produce the sensor data and transmit the sensor data to a relay terminal device;
the data collection processing device includes the relay terminal device, the relay terminal device is configured to collect the sensor data in a predetermined region and transmit the sensor data to a server device, the predetermined region being a region where the relay terminal device is able to receive the sensor data from the plurality of sensor terminal devices;
the data analysis device and the estimation device are equipped by a server device configured to receive the sensor data from the relay terminal device, calculate the number of the users who are staying in the predetermined region based on the user identification information, and estimate density of the users based on the number of the users; and
the alert display device is disposed in a vicinity of the relay terminal device.

11. The data analysis system according to claim 9, wherein
at least one of the data acquisition device or the data collection processing device is configured to add clock time information to the sensor data; and
the data analysis device is configured to:
calculate staying times of the users in the predetermined region based on the clock time information; and
estimate the density of the users in the predetermined region based on the number of the users and the staying times.

12. A server device comprising:
a reception circuit configured to receive sensor data, the sensor data including data acquired by a sensor attached to a user and user identification information for identifying the user;
an ID number calculation processing circuit configured to calculate the number of users staying in a predetermined region based on the user identification information;
an estimation processing circuit configured to estimate density of the users based on the number of users; and
a transmission circuit configured to transmit the density of the users to an alert display device for displaying the density of the users.

13. A data analysis method comprising:
calculating the number of users staying in a predetermined region based on user identification information included in sensor data acquired from a sensor attached to a user; and
analyzing density of the users in the predetermined region based on the number of the users.

14. The data analysis method according to claim 13, further comprising:
estimating that the density of the users is low in a case in which the number of the users staying in the predetermined region is less than a lower limit value of the number of the users.

15. The data analysis method according to claim 14, further comprising:
adding clock time information to the sensor data; and
calculating staying times of the users in the predetermined region based on the clock time information.

16. The data analysis method according to claim 15, further comprising:
estimating that the density is high in a case in which the number of the users staying in the predetermined region is equal to or greater than the lower limit value of the number of the users and greater than an upper limit value of the number of the users.

17. The data analysis method according to claim 16, further comprising:
estimating that the density is high in a case in which the number of the users staying in the predetermined region is equal to or greater than the lower limit value of the number of the users, equal to or less than the upper limit value of the users, and the number of the users who are staying for staying times exceeding an upper limit value of the staying times is equal to or greater than the lower limit value of the number of the users.

18. The data analysis method according to claim 13, wherein the calculating the number of the users comprises:
acquiring sensor data from a sensor attached to a user; and
calculating the number of the users who are staying in a predetermined region based on user identification information included in the sensor data.
